(19) United States
(12) Patent Application Publication
(10) Pub. No.: US 2009/0201840 A1
(43) Pub. Date: Aug. 13, 2009

(54) WIRELESS NETWORKS USING A ROOTED, DIRECTED TOPOLOGY

(76) Inventors: Loren K. Pfeiffer, JR., Canton, OH (US); Kenneth W. Lindsay, Massillon, OH (US)

Correspondence Address: MICHAEL BEST & FRIEDRICH LLP, 100 E WISCONSIN AVENUE, Suite 3300, MILWAUKEE, WI, 53202, US

(21) Appl. No.: 12/330,555

(22) Filed: Dec. 9, 2008

Related U.S. Application Data
(60) Provisional application No. 61/027,194, filed on Feb. 8, 2008.

(51) Int. Cl. H04B 7/00

(52) U.S. Cl. 370/310

(57) ABSTRACT

Systems and methods for establishing a rooted, directed network that acquires and passes sensor data. In one embodiment, the network includes a controller, a logging device, one or more routers, and one or more end nodes. Each network device includes at most one parent node and a unique network message path. The network is established in an ad hoc manner without a need for routing tables. Other embodiments of the invention provide a rooted, directed network for monitoring industrial equipment such, as pumps, fans, rolls, gearboxes, motors, and bearings.

### RELATED APPLICATIONS

This application claims the benefit of prior filed co-pending U.S. provisional patent application Ser. No. 61/027,194, filed Feb. 8, 2008, the entire contents of which are hereby incorporated by reference.

### BACKGROUND

The present invention relates to wireless communications. More particularly, the invention relates to wireless networks designed for use in industrial environments with battery-operated or self-powered nodes, such as sensors used to monitor machine tools, pumps, fans, rolls, gearboxes, motors, bearings, and the like.

Many commercially available communications systems are implemented using mesh networks, which allow communication between otherwise incompatible devices. Mesh networks often include redundancy that requires numerous paths among network devices.

### SUMMARY

Mesh networks are not, however, suitable for all applications. It has been found that networks that can be established quickly without complicated wiring and communication protocols are useful in manufacturing and similar facilities.

In one embodiment, the invention provides a rooted, directed network for acquiring and passing sensor data from an end node to a controller. The network includes a controller that acts as the root of the directed network, a logging device, one or more routers, and one or more end nodes. Each network device is linked to at most one parent node and has a unique network message path to the controller. The network is deployed in an ad hoc manner without a need for routing tables and reduces and, in many instances, eliminates redundancy and cycles between network devices.

In some embodiments, the invention provides a rooted, directed network for monitoring, among other things, industrial equipment such as pumps, fans, rolls, gearboxes, motors, and bearings. Parameters such as temperature and vibration are measured at each end node.

In another embodiment, the invention provides an ad hoc, token-less system for routing data through a rooted, directed, radio frequency (RF) network. The network includes a controller, one or more routers, one or more battery-operated (or self-powered) end nodes, and a logging device. The controller is configured to establish communication paths with other network devices. The controller establishes at most one communication path with any one of the other network devices. The routers are configured to establish communication paths with the end nodes, other routers, and the controller and include no more than one parent node. The routers establish at most one communication path with any one of the end nodes, any one of the routers, and the controller. The end nodes are configured to establish a communication path with either a router or the controller and include no more than one parent node. The end nodes establish at most one communication path with either a router or the controller. The end nodes are also configured to transmit sensor data to the controller. The logging device is configured to store a plurality of messages.

In yet another embodiment, the invention provides a system for routing data through a rooted, directed, wireless network. The network includes a controller, one or more routers, one or more end nodes, and a logging device. The controller is configured to establish communication paths with other network devices. The controller establishes at most one communication path with any one of the other network devices. The controller is also configured to generate network addresses, pass messages to the logging device, generate network messages, and transmit network messages through each communication path. The routers are configured to establish communication paths with a plurality of end nodes, a plurality of other network routers, and the network controller. The routers establish at most one communication path with any one of the end nodes, any one of the routers, and the controller and include no more than one parent node. The routers are also configured to generate network messages and transmit the network messages over each communication path. The end nodes are configured to establish at most one communication path with either a router or the controller and include no more than one parent node. The end nodes are also configured to transmit sensor data to the controller. The logging device is configured to store network messages.

In additional embodiments, the invention provides a method for routing data through a rooted, directed, wireless network. Establishing the network includes designating a controller, initializing routers, initializing end nodes, and designating a logging device. The controller is capable of establishing communication paths with other network devices. The controller establishes at most one communication path with any one of the other network devices. The controller is also capable of generating network addresses, passing messages to the logging device, generating network messages, and transmitting network messages over each communication path. The routers are capable of establishing communication paths with end nodes, other network routers, and the controller. The routers establish at most one communication path with any one of the end nodes, other routers, and the controller and include no more than one parent node. The routers are also capable of generating network messages and transmitting network messages over each communication path. The end nodes are capable of establishing at most one communication path with either a router or the controller and include no more than one parent node. The end nodes are also configured to transmit sensor data to the controller. The logging device is capable of storing network messages.

Other aspects of the invention will become apparent by consideration of the detailed description and accompanying drawings.

### BRIEF DESCRIPTION OF THE DRAWINGS

FIG. 1 illustrates an exemplary embodiment of a rooted, directed network.

FIG. 2 illustrates an exemplary embodiment of a star network topology.

FIG. 3 illustrates an exemplary embodiment of a tree network topology.

FIG. 4 illustrates basic network message flow dynamics between network devices.

FIG. 5 illustrates an exemplary network formation process.

FIG. 6 illustrates message flow in a network with a controller, logging device, and router.

FIG. 7 illustrates an embodiment of a state diagram for a controller.

FIG. 8 illustrates an embodiment of a state diagram for a router.

FIG. 9 illustrates an embodiment of a state diagram for an end node.

FIG. 10 illustrates an embodiment of end node firmware.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

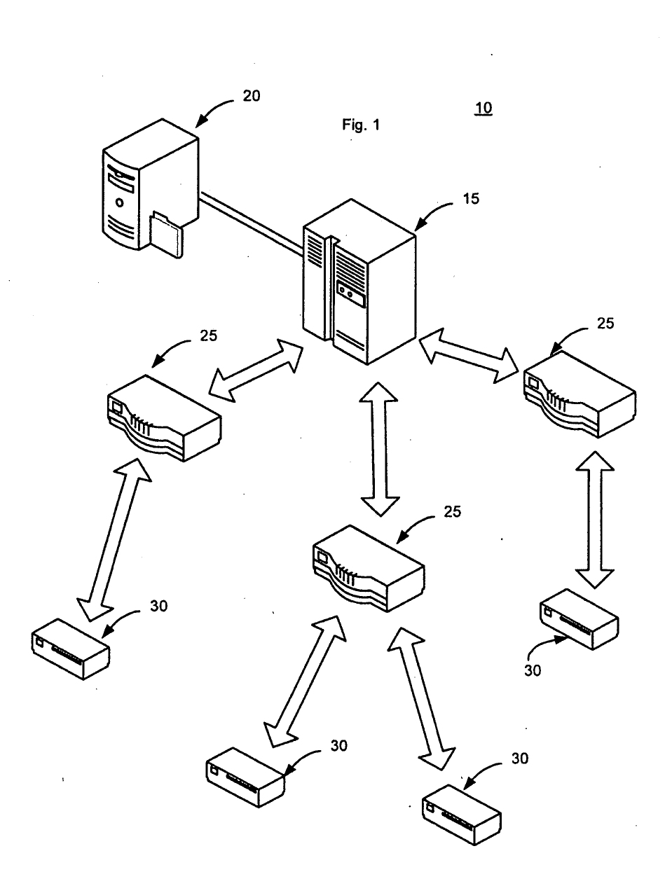

FIG. 1 illustrates an exemplary embodiment of a rooted, directed network 10. The rooted, directed network includes a controller 15, a logging device 20, one or more routers 25, and one or more end nodes 30.

The controller 15 is configured to gather data from the routers and the end nodes and transfer the data to the logging device 20. The logging device 20 includes memory, a central processing unit (CPU), and an input unit for receiving system messages. The logging device 20 runs programs by executing computer instructions fetched from memory. The logging device 20 also records information from a plurality of network messages. In one embodiment, the logging device 20 records a set of ASCII strings from a network message such as a sensor data message described below. The one or more routers 25 are configured to generate and pass messages between network components. For example, routers 25 function as nodes that pass messages between the end node 30 and the controller 15. The one or more end nodes 30 are configured to collect sensor data and generate and pass messages to the controller 15.

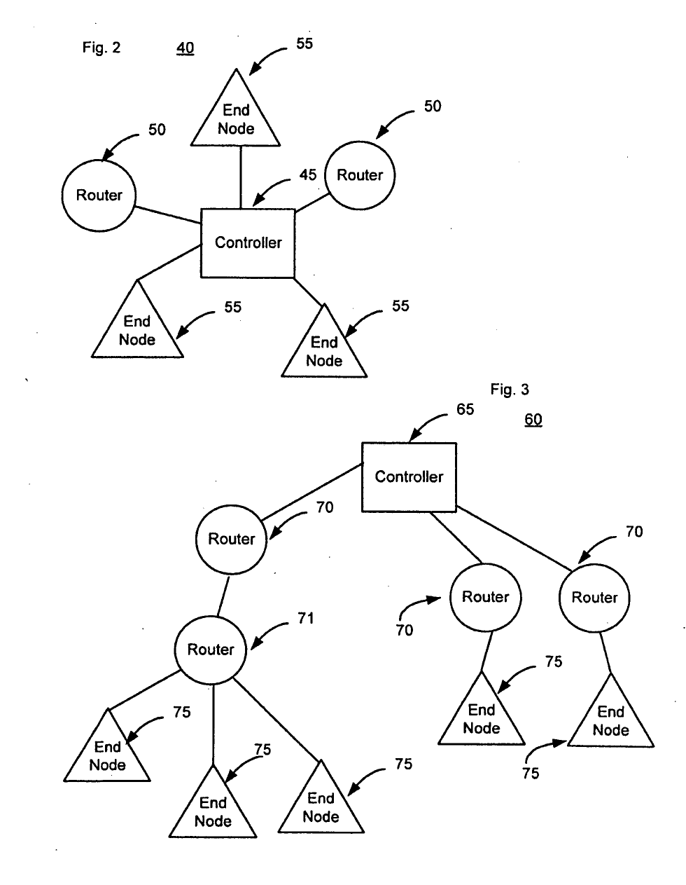

The network 10 is deployed in either a star or a tree topology. An exemplary embodiment of a star topology network 40 is illustrated in FIG. 2. The star topology network 40 includes a controller 45, one or more routers 50, and one or more end nodes 55. In the star topology network 40, the controller 45 is central to the other network devices. Each network device is at most one network level away from the controller 45 and messages are passed directly to the controller 45 from the routers 50 and the end nodes 55.

A tree topology network 60, as illustrated in FIG. 3, is a multi-level network that includes a controller 65 connected to a plurality of network nodes such as first-level routers 70. Each of the first-level routers 70 is, in turn, connected to additional nodes at lower levels of the network. A lower level node is a node that is further away (more hops) from the central node (controller 65) relative to a second node. For example, in the tree network 60, the lowest level network nodes are third-level end nodes 75 connected to second-level router 71, which is, in turn, connected to the first-level router 70 and the controller 65. While embodiments of the invention that incorporate star networks can be implemented, all references hereinafter made to the network 10 refer to a rooted, directed tree network.

In the exemplary embodiment of the rooted, directed network 10 from FIG. 1, the controller 15 shares a wired connection with the logging device 20. However, in other embodiments the connection between the controller 15 and the logging device 20 is wireless. The connections between the controller 15, the first-level routers 25, and the second-level end nodes 30 are wireless. Additionally, the network 10 has no more than one data path between any two network devices. For example, any one of the end nodes 30 has only one path between it and the controller 15 or any of the routers 25. In the described embodiment, one of the end nodes 30 cannot communicate with another end node 30. It is possible, however, for an end node 30 to communicate directly with the controller 15 without first communicating with a router 25. Therefore, in the exemplary embodiment of the network 10, each network device has at most one other network device as a parent node. By having at most one parent node and a unique path to the controller, unnecessary redundancy and cycles are avoided.

Redundancy includes having multiple superfluous data paths between two points in a network. For example, in a mesh network, every node can be in communication with every other node such that a single message could have multiple active data paths between an origination node and a destination node. Implementing a redundant network often requires the network to use a routing lookup table to direct messages, which consumes system resources. Multiple active data paths also introduce the potential for data cycles. A data cycle can occur when a first node is unable to recognize a network level for a second node, and the first and second nodes are on the same network level. As a result, a message can be continually passed between nodes at the same level. An endless loop can result that consumes available CPU resources and bandwidth and, in some instances, cause a loss of data.

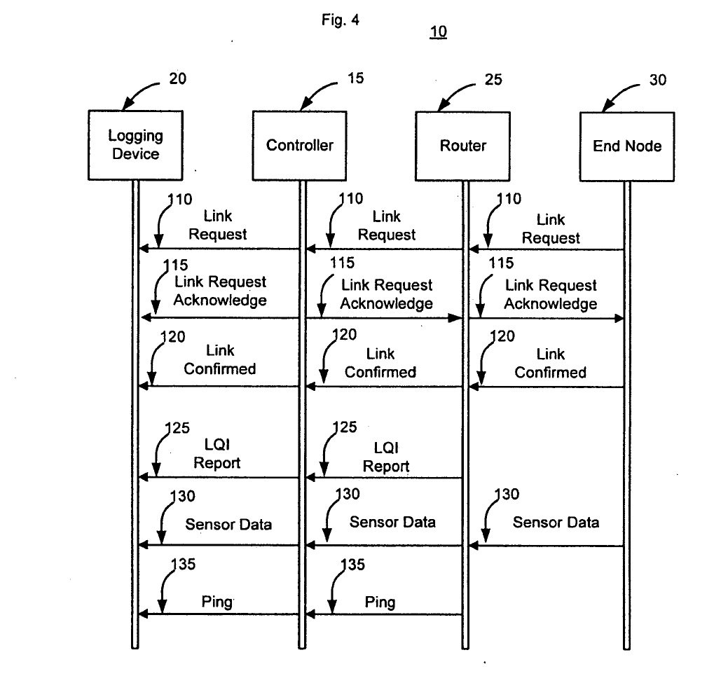

An overview of basic message flow dynamics between network devices for the network 10 is illustrated in FIG. 4. Similar to FIG. 1, the network 10 includes the controller 15, the logging device 20, the router 25, and the end node 30. The transmission of messages within the network 10 is classified into network formation, network integrity, network quality, and data acquisition. Each of the four message classifications are described in further detail below. With respect to FIG. 4, a link request message 110, a link request acknowledge message 115, and a link confirmed message 120 are related to network formation. A link quality index report (LQI report) 125 is related to network quality. A ping message 135 is related to network integrity, and the sensor data message 130 is related to data acquisition. In other embodiments, there are additional messages that are sent between the network devices.

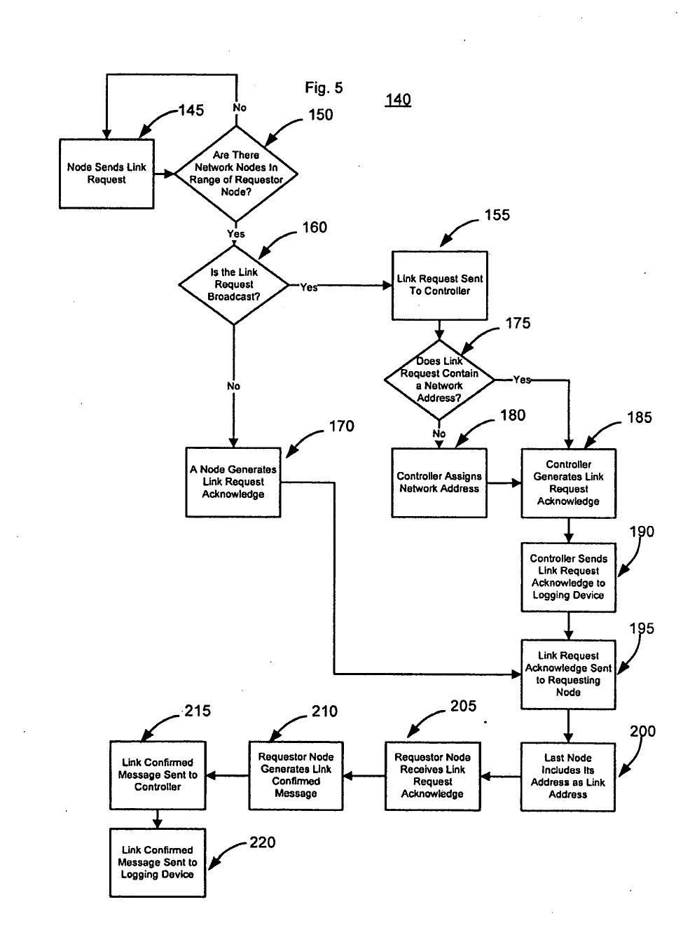

An exemplary embodiment of a network formation process 140 is illustrated in FIG. 5. The process 140 is described with respect to a network similar to the network 10 from FIG. 1. The process 140 ensures that the network contains no cycles. Each network device is powered and linked to each other as described above. A node sends a link request message to any network node in range such as a router or a controller (step 145). If there are no network nodes in range, the requester node cannot link to the network. If there are network nodes in range (step 150), the nodes determine if the requestor node has broadcast the link request message (step 160). If the requestor node has not broadcast the link request message, only the node (controller or router) whose address appears as the destination in the message can generate a link request acknowledge message (step 170) and send the link request acknowledge message to the requestor node (step 195). If the requestor node did broadcast the link request message, the message is sent to the controller (step 155). After the controller receives the link request, the controller must determine whether the link contains an assigned network address (step 175). If the link request does not contain a network address, the controller assigns a network address to the requestor node (step 180) and generates a link request acknowledge message (step 185). If the link request contains a network address, then the controller only generates the link request acknowledge message (step 185). After the controller generates the link request acknowledge message, the controller sends the link request acknowledge message to the logging device (step 190) and then to the requestor node (step 195). The network address of the requestor node is then placed in a link-pending table until a link confirmed message is received.

Because each network node only knows the network address of its parent node, without using another mechanism, messages cannot be passed through the network away from the controller. As a result, a message address stack is used. If a node requires a reply to a message sent to the controller, the requesting message flows up the hierarchy toward the controller. Each node the message passes through places its network address on the top of the message address stack. When a message flows down the hierarchy toward an end node, each node the message passes through removes its address from the message address stack. The message address stack assists in preventing cycles and redundancy.

A distinction is made between a broadcast link request message and a non-broadcast link request message. A broadcast link request message is a message sent by a node without a network address in an attempt to link with the network. A non-broadcast link request message is a message sent by a node that already has a network address. It is possible for a node to be linked to the network and temporarily lose connection with the network. In such an event, the node attempts to reconnect to the same network device that it was previously connected to. The node sends a link request message to that device that contains a network address. If the node is unable to reconnect to that device, the node attempts to connect to the network via a broadcast link request message.

Referring once again to FIG. 5, after the link request acknowledge message is sent to the requester node, the final node on the path to the requestor node inserts its network address as a link address (step 200). The link address then corresponds to the parent of the requestor node. After step 200, the requestor node receives the link request acknowledge message (step 205) and generates the link confirmed message (step 210). The link confirmed message is sent to the controller (step 215) and the controller sends the link confirmed message to the logging device (step 220). After the controller receives the link confirmed message, the requestor node's network address is removed from the link-pending table.

If during network formation, more than one network node is in range of the requesting node, the requestor node links to the first node to answer the link request message. For example, if a requestor node is within range of both the controller and a network router, the first of the controller and the network router to send a link request acknowledge message is linked to the requestor node. No precedence is in place for the requestor node to link to the controller if the controller is in range of the requestor node. As recited above, if the requestor node broadcasts the link request message, the message must be sent to the controller which eliminates cycles in the network.

Additionally, it is noted that the network 10 is formed in a token-less manner. Tokens are sometimes used to establish parent-child relationships within a network without redundancy or cycles. For example, if a node attempts to connect to a network, the node is only able to connect to the network if the node and the network each have a token. If both the node and the connecting device within the network have tokens, the node is connected to the network and one of the tokens is consumed by the network. If the node does not have a token, it cannot connect to the network. In contrast, the network 10 does not use tokens and a node is able to establish a parent-child relationship with the router 25 or the controller 15 while maintaining a network without redundancy and cycles. The network 10 is also asynchronous and does not require any scheduling tables for formation, message passing, or entering/exiting sleep modes.

After network formation is complete and an end node is linked to the network, the end node begins sending sensor data back to the controller. The amount of data that is sent to the controller depends on the embodiment of the invention. In some embodiments, sensor data messages are sent once every fifteen seconds. In other embodiments, sensor data packets are sent at different frequencies. Each sensor data message includes a node ID representative of the end node sending the sensor data message, as well as an entirety of raw and reduced data generated by the end node. In one embodiment, ninety-six bytes of the sensor data message is allocated for sensor data. After the controller receives the sensor data message, it is sent to the logging device. In other embodiments, more or fewer bytes are allocated for sensor data.

The type of data sent to the controller is also dependent on the embodiment of the invention. For example, in one embodiment, an end node uses a temperature probe to monitor the temperature of the environment around the end node. In other embodiments, additional parameters such as vibration may be measured. For example, in embodiments of the invention, machines such as pumps, fans, rolls, gearboxes, motors, bearings, and other industrial devices or systems may be monitored. In one embodiment, an accelerometer is used to measure the vibration of a bearing. The accelerometer may include multiple vibration ranges that provide for either a wider range of vibrational measurements or a better data resolution. The vibrational measurements are recorded with respect to time and may indicate, for example, a spall propagation of a bearing.

In some embodiments, the directed network includes the ability to measure the quality of a wireless signal between any two linked nodes. The quality of the wireless signal between any two nodes is captured in a link quality index (LQI) report 125. The LQI report 125 is generated by either the controller or one of the routers linked to the network. If an end node is linked directly to the controller, the controller generates the LQI report 125 and sends it to the logging device. A router generates the LQI report 125 during network formation and at periodic intervals when the router is passing sensor data messages to the controller. The information in an LQI report 125 may be used during system installation or by a system user to adjust the position or number of routers relative to the end nodes and controller to establish reliable data paths.

Another exemplary embodiment of the rooted, directed network includes an ability to monitor network integrity. During normal operation, messages pass between network nodes. The continuous passing of data between network devices functions as a verification of the networks integrity. However, if no messages pass through a data path, the integrity of the path is unknown. When the integrity of a data path is unknown, a router sends a ping message 135 to its link address. The ping message 135 functions as an indication to the receiving node to generate an LQI report 125. The LQI report 125, in turn, provides information about the integrity of the data path.

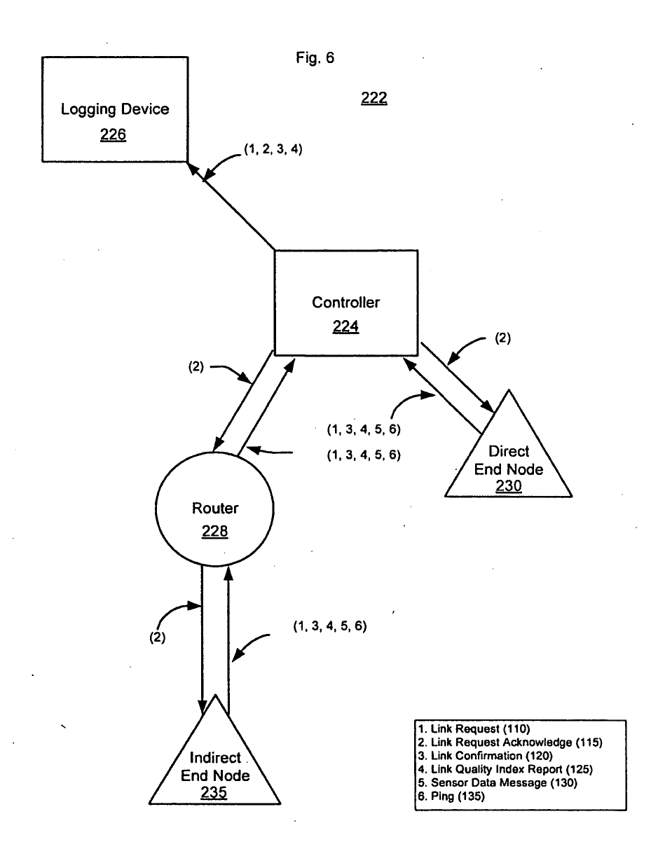

An illustration of information flow between network devices is provided in FIG. 6 for a network 222, which includes a controller 224, a logging device 226, a router 228, and two end nodes: a direct end node 230 and an indirect end node 235. Information flow between the controller 224 and the logging device 226 consists of four messages: the link request message 110, the link request acknowledge message 115, the link confirmation message 120, and the sensor data message 130. Each message flows from the controller 224 to the logging device 226, never from the logging device 226 to the controller 224. Information flow between the controller 224, the router 228, the direct end node 230, and the indirect end node 235 includes additional messages that are not sent to the logging device 226. Each message flows up the hierarchy or down the hierarchy. Up the hierarchy is defined as toward the controller 224, and down the hierarchy is defined as away from the controller 224. In the described embodiment, the indirect node 235 is the lowest point in the hierarchy, and the controller 224 is the highest point in the hierarchy. The logging device 226 is not considered the highest point in the hierarchy because it is only used for receiving and storing certain messages and only receives messages from the controller 224.

The information flow between the controller 224, the router 228, the direct node 230, and the indirect node 235 each include a plurality of messages. A link request message 110 can be sent by the router 228, the direct end node 230, or the indirect end node 235. The link request message 110 flows up the hierarchy toward the controller 224. A link request acknowledge message 115 is sent by either the controller 224 or the router 228. The link request acknowledge message 115 flows down the hierarchy. For example, if the controller 224 generates a link request acknowledge message 115 and the indirect end node 235 is the requestor node, the link request acknowledge message 115 is sent through the router 228 toward the indirect end node 235. A link confirmation message 120 flows up the hierarchy. For example, the link confirmation message 120 is sent from a requester node such as the direct node 230 to the controller 224 and ultimately to the logging device 226. A sensor data message 130 generated by the end nodes (direct or indirect) flows up the hierarchy toward the controller 224 and then to the logging device 226. A link quality index report message 125 also flows up the hierarchy toward the controller 224. The link quality index report message 125 can be generated by any of the end nodes or routers 228. A ping message 135 flows up the hierarchy toward the controller 224 and can be periodically generated by the router 228.

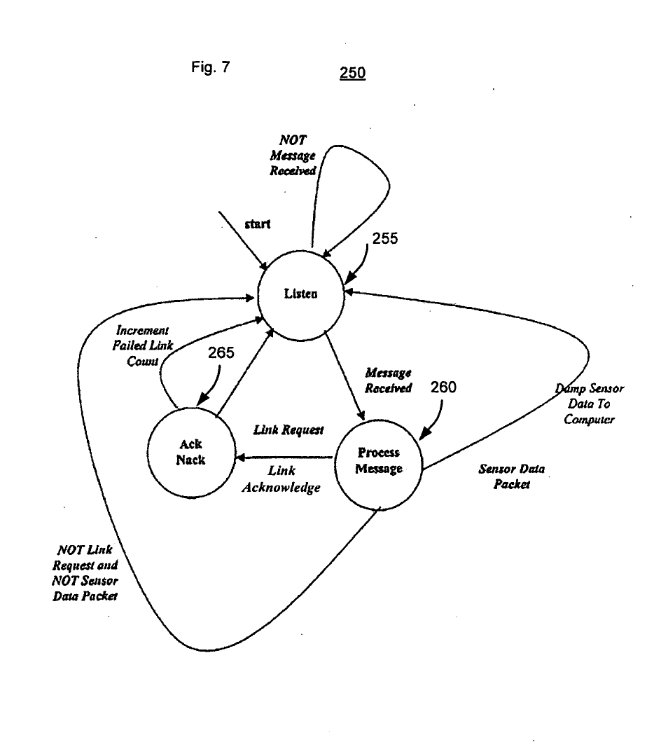

FIG. 7 illustrates a state diagram 250 for the controller 15 described with respect to the network 10 from FIG. 1. The default state of the controller 15 is a listen state 255. During the listen state 255, the controller 15 waits to receive a message. If no message is received, the controller 15 continues to listen until a message is received. If the controller 15 receives a message, the controller 15 proceeds to a process message state 260. During the process message state 260, the controller 15 determines what type of message it received. If the message was a sensor data message 130, the controller 15 sends the sensor data message to the logging device 20 and returns to the listen state 255. If the message was a link request, the controller 15 proceeds to an ack/nack state 265 after sending a link request acknowledge message. During the ack/nack state 265, if the link request acknowledge was sent correctly, the controller 15 returns to the listen state 255. If the link request acknowledge message was not sent correctly, the controller 15 increments a failed link counter and returns to the listen state 255. If the controller 15 receives a message that is neither a link request nor a sensor data message, the controller 15 returns to the listen state 255.

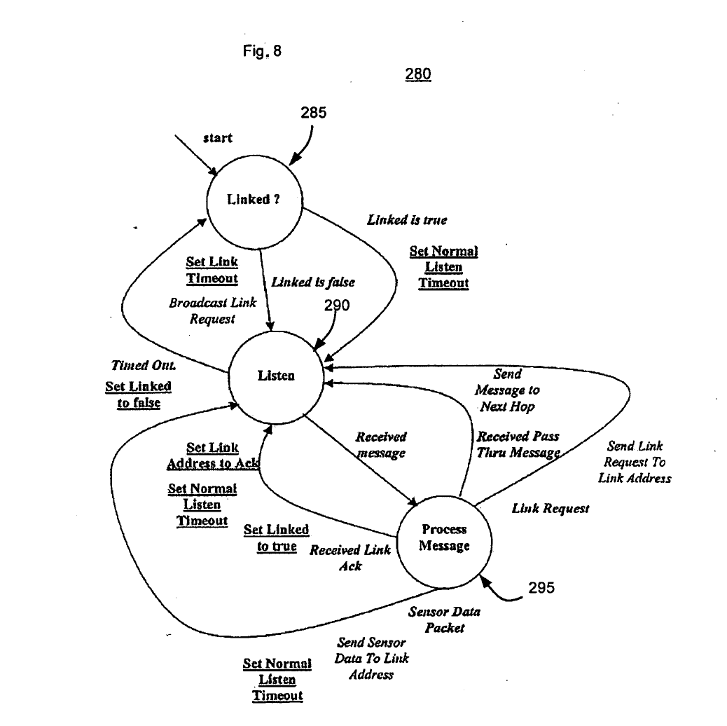

A state diagram 280 for the router 25 (FIG. 1) is illustrated in FIG. 8. The default state for the router 25 is a linked state 285. In the linked state 285, the router 25 checks its link status. If the router 25 is not linked to the network, the router 25 broadcasts a link request, sets a link timeout, and enters a listen state 290. If the router 25 does not receive a link request acknowledge message before the link timeout occurs, the router 25 re-enters the linked state 285. If a timeout occurs, a broadcast failed counter is incremented to track the number of broadcast failures the router experiences. If the router 25 is linked to the network, a normal listen timeout is set and the router 25 enters the listen state 290. If no messages are received before the normal link timeout occurs, the router 25 returns to the linked state 285.

If the router 25 receives a message while in the listen state 290, the router 25 proceeds to a process message state 295. If the router 25 receives a link request message, the router sends the link request to the link address. If the router 25 receives a pass through message, the router 25 takes its address off the address stack and sends the message to the next network level on the message's destination path. If the router 25 receives a link request acknowledge message, the router 25 sets its link status to true, sets the normal listen timeout, and sets a linked-to address before returning to the listen state 290. If the router 25 receives a sensor data message, the router 25 sends the sensor data message to the link address, sets a normal listen timeout, and returns to the listen state 290.

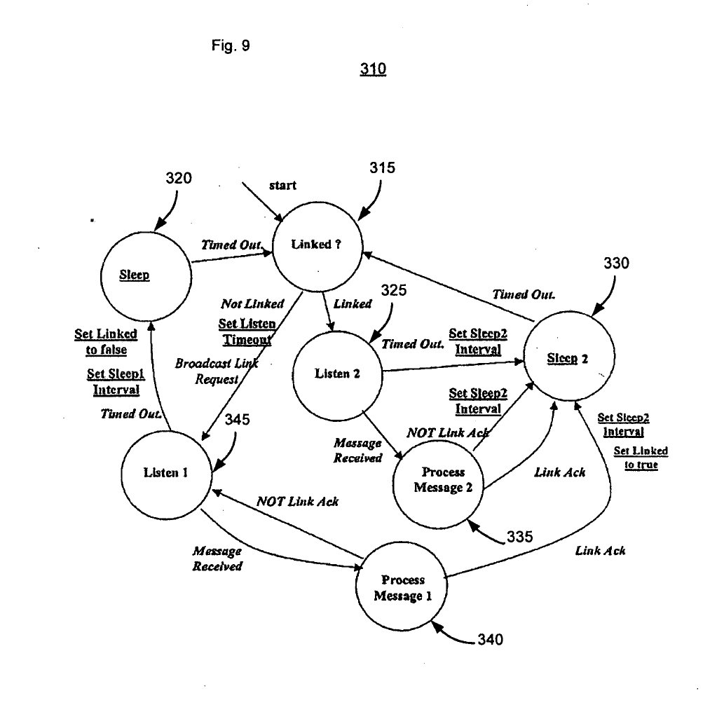

FIG. 9 illustrates a state diagram 310 for a network end node 30 (FIG. 1). The default state for the end node is a linked state 315. If the end node 30 is not linked to the network, it sets a listen timeout, broadcasts a link request message, and enters a first listen state 345. If no message is received in the first listen state 345 before the listen timeout occurs, the end node 30's link status is set to false, a first sleep interval is set, and the end node 30 enters a sleep state 320. After the sleep interval expires, the end node 30 re-enters the linked state 315. If during the first listen state 345, a message is received, the end node 30 enters a first process message state 340. If the message is a link request acknowledge message, the end node 30 sets its link status as true, sets a second sleep interval, sets a linked-to address, and enters a second sleep state 330.

If the end node's 30 link status is true, the end node 30 enters a second listen state 325 and sets a normal listen timeout. If the listen timeout expires before the end node 30 receives a message, the second sleep interval is set and the end node 30 enters the second sleep state 330. After the second sleep interval expires, the end node 30 re-enters the linked state 315. If the end node 30 receives a message before the normal listen timeout expires, the end node 30 enters a second process message state 335. If the message is a link request acknowledge message, the second sleep interval is set, the linked-to address is set, and the link status is set to true before entering the second sleep state 330. If the message is not a link request acknowledge, the second sleep interval is set and the end node 30 enters the second sleep state 330. After the second sleep interval expires, the end node 30 re-enters the linked state 315.

Although not shown in the state diagram, after the end node 30 is linked to the network, the end node 30 sets a listen timeout and sends a sensor data message to the designated link address. In other embodiments, the end node 30 may proceed to additional states, set additional timers, and receive additional messages.

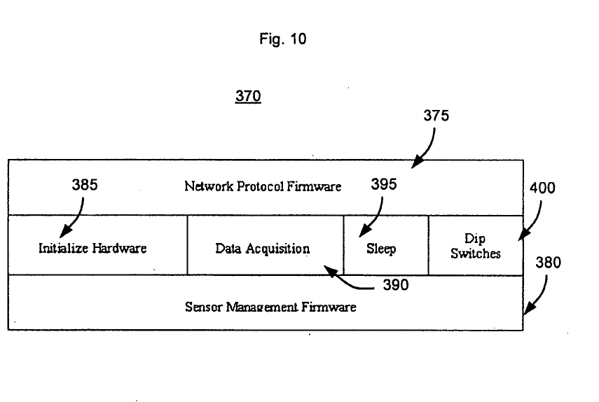

Each end node 30 also includes end node firmware 370 (FIG. 10) that acts as a controlling element for the end node 30. In an exemplary embodiment, the firmware 370 includes network protocol firmware 375, sensor management firmware 380, and a number of main functions for network firmware access. These functions include an initialize hardware routine 385, which is implemented to set up and verify proper functioning of the end node. A data acquisition routine 390 is implemented so the end node is able to acquire sensor data. In some embodiments, an end node is designed to conserve energy and a sleep routine 395 is implemented. The end node enters a sleep state after a predefined timeout occurs, for example, a predefined time limit between receiving network messages. A read DIP-switches routing 400 can also be implemented if multiple settings, for example, multiple sleep intervals, are available on the end node. A user or installer of the system can then set the DIP-switches to a desired configuration. In other embodiments, additional routines are implemented in the firmware.

Thus, the invention provides, among other things, a sensor-driven wireless network. In exemplary embodiments, the network is a rooted, directed network for passing sensor data from and end node to a controller.

Various features and advantages of the invention are set forth in the following claims.

What is claimed is:

1. A token-less system for routing data from sensors, the system comprising:
a rooted, directed network, the network including
a network controller configured to
establish communication paths with a plurality of other network devices,
wherein there is at most one communication path between the controller and any one of the plurality of other network devices;
one or more self-powered end nodes, each of the self-powered end nodes having no more than one parent node and configured to
establish a communication path with the network controller,
wherein there is at most one communication path between one of the one or more end nodes and the network controller, and
each of the end nodes transmits sensor data to the network controller.

2. The system of claim 1, further comprising
one or more network routers, each of the network routers having no more than one parent node and configured to
establish communication paths with a plurality of end nodes, a plurality of other network routers, and the network controller,
wherein there is at most one communication path between one of the one or more network routers and any one of the plurality of end nodes, any one of the plurality of other network routers, and the network controller.

3. The system of claim 1, wherein the network controller is further configured to generate
a network address,
a network link request acknowledgement, and
a quality report.

4. The system of claim 1, wherein the network controller is further configured to transmit
a network link request confirmation,
a network link request,
a quality report, and
a data packet.

5. The system of claim 2, wherein each of the one or more network routers is further configured to generate
a network link request acknowledgement, and c
a quality report.

6. The system of claim 2, wherein each of the one or more network routers is further configured to transmit
a network link request,
a network link request acknowledgement,
a network link request confirmation,
a quality report, and
a data packet.

7. The system of claim 1, wherein the rooted, directed network is established in an ad hoc manner.

8. The system of claim 1, wherein the rooted, directed network is a radio frequency network.

9. The system of claim 1, wherein the sensor data includes temperature data.

10. The system of claim 1, wherein the sensor data includes vibration data.

11. The system of claim 1, further comprising a logging device configured to store a plurality of messages.

12. A system for monitoring industrial equipment, the system comprising:
a rooted, directed network, the network including
a network controller configured to
establish communication paths with a plurality of other network devices,
wherein there is at most one communication path between the controller and any one of the plurality of other network devices;
one or more network routers, each of the network routers having no more than one parent node and configured to
establish communication paths with a plurality of industrial monitoring devices, a plurality of other network routers, and the network controller,
wherein there is at most one communication path between one of the one or more network routers and any one of the plurality of industrial monitoring devices, any one of the plurality of other network routers, and the network controller.
one or more industrial monitoring devices, each of the industrial monitoring devices linked to no more than one parent node and configured to
establish a communication path with one of the network routers or the network controller,
wherein there is at most one communication path between one of the one or more industrial monitoring devices and any one of the one or more network routers or the network controller,
each of the industrial monitoring devices further configured to transmit sensor data to the network controller.

13. The system of claim 12, further comprising a logging device configured to store a plurality of messages.

14. The system of claim 12, wherein the industrial monitoring devices includes a temperature sensor.

15. The system of claim 12, wherein the industrial monitoring devices include a vibration sensor.

16. The system of claim 12, wherein the rooted, directed network is a token-less network.

17. The system of claim 12, wherein the rooted, directed network is an RF network.

18. The system of claim 12, wherein the network is established in an ad hoc manner.

19. A method for routing data, the method comprising:
establishing a rooted, directed wireless network by
designating a network controller, the network controller capable of
establishing, in an ad hoc manner, communication paths with a plurality of other network devices,
wherein there is at most one communication path between the controller and any one of the plurality of other network devices,
the network controller further capable of
generating network addresses,
passing messages to a logging device,
generating one or more network messages, and
transmitting one or more network messages over each communication path;
initializing one or more battery-operated network end nodes, the battery-operated network end nodes having no more than one parent node and capable of
establishing a communication path with one of a network router or the network controller,
wherein there is at most one communication path between one of the one or more end nodes and the network controller,
the end nodes further configured to transmit sensor data to the controller.

20. The method of claim 19, further comprising
initializing one or more network routers, each of the network routers having no more than one parent node and capable of
establishing communication paths with a plurality of end nodes, a plurality of other network routers, and the network controller,
wherein there is at most one communication path between one of the one or more network routers and any one of the one or more end nodes, any one of the one or more other network routers, and the network controller.

21. The method of claim 20, further comprising configuring each of the network routers to generate one or more network messages and transmitting one or more network messages over each communication path.

22. The method of claim 19, further comprising configuring the controller to
generate a network address,
generate a network link request acknowledgement,
generate a quality report,
transmit a network link request confirmation,
transmit a quality report,
transmit a network link request, and
transmit a data packet.

23. The method of claim 19, wherein establishing a rooted, directed wireless network includes establishing a token-less network.

24. The method of claim 19, wherein establishing a rooted, directed wireless network includes establishing a radio frequency network.

25. The method of claim 19, further comprising designating a logging device configured to store a plurality of network messages.
